(19) United States
(12) Patent Application Publication
(10) Pub. No.: US 2008/0107830 A1
(43) Pub. Date: May 8, 2008

(54) IMAGE-PROVIDING APPARATUS AND METHOD FOR COMMUNICATION DEVICE

(75) Inventors: LOUIS J. LUNDELL, BUFFALO GROVE, IL (US); CHRISTOPHER A. ARNHOLT, HIGHLAND PARK, IL (US); JOHN A. BURROUGHS, LAKE ZURICH, IL (US); PATRICK J. CAUWELS, SOUTH BELOIT, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/934,261

(22) Filed: Nov. 2, 2007

Related U.S. Application Data
(60) Provisional application No. 60/864,228, filed on Nov. 3, 2006.

(51) Int. Cl. C09K 19/02

(52) U.S. Cl. 428/1.2

(57) ABSTRACT

A structure and related method of providing a morphing appearance of a surface of such a structure can be implemented in relation to a wireless communication device such as a cellular telephone. In at least one embodiment, the structure is implemented in a cellular telephone and includes a first layer and a second layer positioned behind the first layer. The first layer is configured to restrict a viewing of the second layer from a first location in front of the first layer when a view path between the first location and the structure forms an angle relative to an axis extending from the structure that exceeds an angular threshold, whereby first and second images that differ from one another are respectively provided by the structure and visible at the first location depending upon whether the view path exceeds or does not exceed the angular threshold, respectively.

### FIELD OF THE INVENTION

The present invention relates to features implemented on communication devices such as cellular telephones.

### BACKGROUND OF THE INVENTION

Wireless communication devices such as cellular telephones, pagers, personal digital assistants, other handheld devices, laptop/notebook personal computers, and other devices are ubiquitous in the modern world. Such communication devices typically have one or more human-machine interfaces, such as a LCD screen on which are displayed images, and one or more buttons by which an operator can enter commands. In some cases, a touch-sensitive panel (or even touchscreen) can be employed, by which an operator can provide commands by applying pressure upon one or more regions of the panel that may or may not be configured to resemble buttons.

While many human-machine interfaces have already been developed for implementation in wireless communication devices that are relatively inexpensive, relatively easy to use and otherwise functionally adequate, there is a continuing need for human-machine interfaces with additional or improved features. For example, in the case of small, portable wireless communication devices such as cellular telephones, there is a continuing need for improved touch-sensitive panels that are thin and lightweight, and yet at the same time are attractive and versatile. In the case of at least some such devices, it would be particularly desirable if properties of a panel, for example, an operational configuration or a visual look of the panel, could vary depending upon operational or operator circumstances.

### BRIEF SUMMARY OF THE INVENTION

In at least some embodiments, the present invention relates to a structure configured to provide multiple visual images in a cellular telephone. The structure includes a first layer and a second layer positioned behind the first layer, the first and second layers being supported upon the cellular telephone. The first layer is configured to restrict a viewing of the second layer from a first location in front of the first layer when a view path between the first location and the structure forms an angle relative to an axis extending from the structure that exceeds an angular threshold, whereby first and second images that differ from one another are respectively provided by the structure and visible at the first location depending upon whether the view path exceeds or does not exceed the angular threshold, respectively.

Additionally, in at least some embodiments, the present invention relates to a touch panel for a wireless communication device. The touch panel includes a first layer that forms an exterior surface of the touch panel, a second layer that includes a privacy film layer, and a third layer behind the second layer that provides a first image. The first image is substantially only visible from a location beyond the exterior surface of the touch panel if a path extending between the location and the exterior surface is within a first angular range of an axis extending from the exterior surface.

Further, in at least some embodiments, the present invention relates to a method of providing a morphing appearance of a surface of a wireless communication device. The method includes providing a cellular telephone having a structure including a privacy film layer and an image-creating layer behind the privacy film layer. The method additionally includes providing first output light that communicates at least a portion of a first image determined by the image-creating layer when the output light is transmitted by way of a first path that is within a first angular range of a direction relative to the surface of the structure. The method further includes providing second output light that communicates at least a portion of a second image differing from the first image when the output light is transmitted by way of a second path that is outside of the first angular range.

### BRIEF DESCRIPTION OF THE DRAWINGS

FIG. 1A is a front elevation view of an exemplary wireless communication device having a touch-sensitive panel in accordance with at least some embodiments of the present invention;

FIG. 1B is a perspective, side elevation view of the exemplary wireless communication device of FIG. 1A;

FIG. 2 is a block diagram showing exemplary internal components of the wireless communication device of FIGS. 1A-1B; and

FIGS. 3-5 are three schematic cross-sectional views of exemplary component layers of the touch-sensitive panel of the wireless communication device of FIGS. 1A, 1B and 2, taken along a line 3-3 of FIG. 1A.

### DETAILED DESCRIPTION OF THE INVENTION

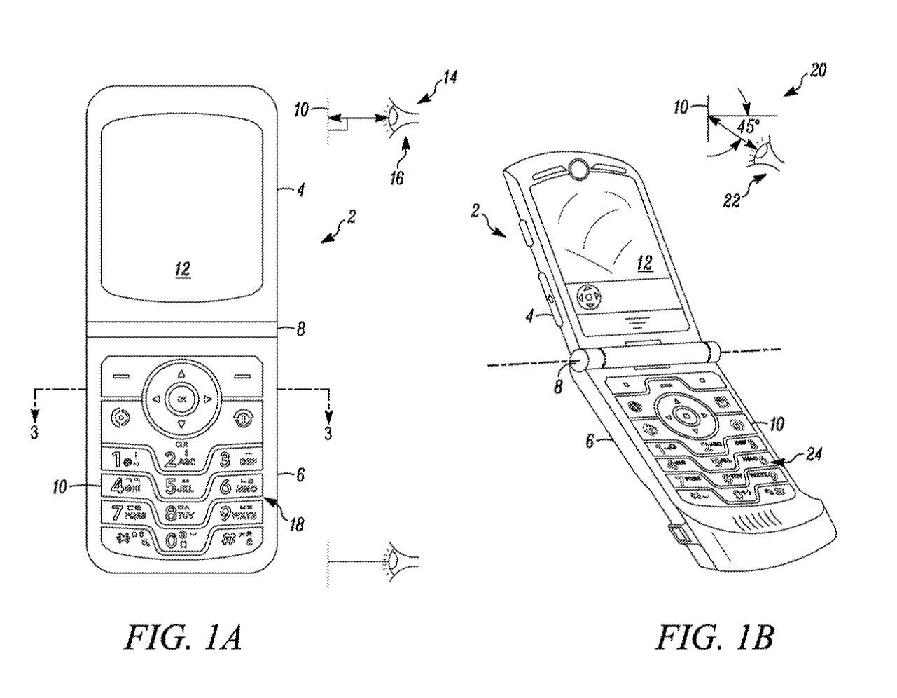

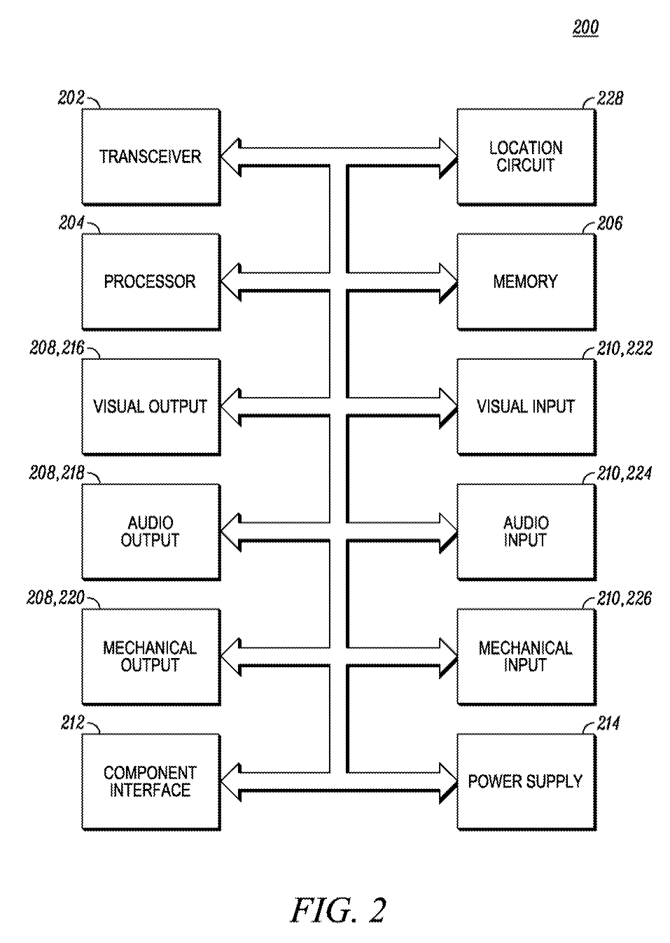

Referring to FIGS. 1A and 1B, an exemplary wireless communication device is shown that, in the present embodiment, is a cellular telephone 2. FIG. 1A in particular shows a front elevation view of the telephone 2, while FIG. 1B shows a side perspective view of the telephone. As shown, the cellular telephone 2 is a clamshell-type phone having an upper flip section 4 and a lower flip section 6 that are coupled together in a hinged or rotatable manner by way of a hinge or similar mechanism, which in the present embodiment is shown as a hinge 8.

More particularly, FIGS. 1A-1B show the cellular telephone 2 to be in an open position such that the upper flip section 4 and lower flip section 6 generally extend away from the hinge 8 and extend away from one another. When in such an open position, the upper and lower flip sections 4, 6 need not be exactly diametrically opposed such that the flip sections form a 180° angle between them (assuming the hinge 8 to be the vertex). Rather, the upper and lower flip sections 4, 6 when in the open position can be positioned so as to extend substantially away from one another, for example, such that the flip sections form an angle of approximately 160° to 175° between them, as is intended to be illustrated by FIG. 1B.

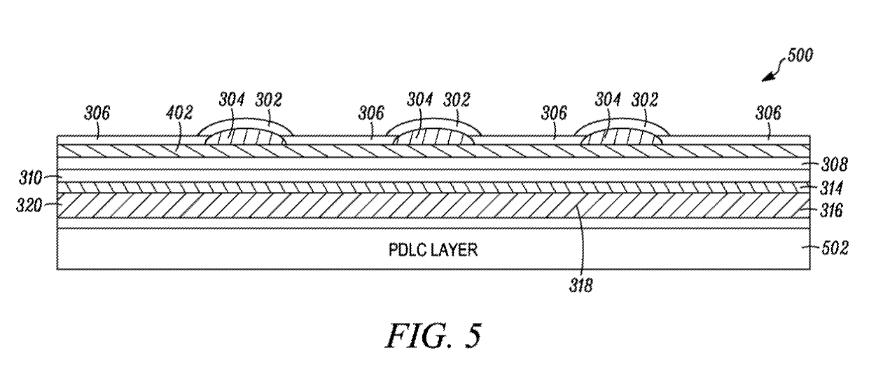

In the present embodiment, the lower flip section 6 of the cellular telephone 2 can be considered to be the mouthpiece of the phone while the upper flip section 4 can be considered to be the earpiece of the phone. Further, in accordance with the present arrangement, the cellular telephone 2 on the upper flip section 4 includes a display 12, which can for example be a liquid crystal display (LCD), and on the lower flip section 6 includes a touch-sensitive panel (or simply “touch panel”) 10. Exemplary component layers of the touch panel 10 are described in further detail below with respect to FIGS. 3-5. It should be noted that the use of the terms “upper” and “lower” in describing the flip sections 4, 6 as well as the use of similar relational terms such as “below” in relation to the components shown in FIGS. 3-5 is for convenience herein and should not be interpreted as requiring any particular arrangement of the sections or components with reference to the ground or otherwise.

As shown by a comparison of FIGS. 1A and 1B, in accordance with at least some embodiments of the present invention, the touch panel 10 is specially designed so that the visual images that appear to be provided by the touch panel vary depending upon a viewer's location relative to the touch panel. More particularly, as shown schematically in FIG. 1A by a diagram 14, when a viewer represented by an eye 16 is viewing the touch panel 10 of the phone at an angle normal to the surface of the touch panel, then a first visual image 18 appears to be provided by the touch panel (in this example, the image is an array of eighteen buttons and dashed lines criss-crossing those buttons). The same image would be viewed if the orientation of the viewer (e.g., the eye 16) was moved off from normal by within a certain threshold number of degrees (e.g., within 30 degrees).

However, as shown schematically in FIG. 1B by a diagram 20, when a viewer represented by an eye 22 is viewing the touch panel 10 of the cellular telephone 2 at an angle off of the normal that is beyond the certain number of degrees (in this example, 45 degrees), then a second visual image 24 appears to be provided by the touch panel. For example, as shown in FIG. 1B, an advertising or similar message, e.g., the words “HELLO MOTO”, can be visible on the touch panel 10, but the array of buttons and dashed lines of the image 18 are no longer visible. Thus, as a viewer moves from the position relative to the touch panel 10 shown in FIG. 1A to the position shown in FIG. 1B, and back again, the visual image experienced by viewer switches back and forth between the first and second visual images 18, 24.

It should be noted that the “viewer” that views the images provided by the touch panel 10 in FIGS. 1A and 1B, although represented by the eyes 16, 22, can be any of a variety of persons, animals or devices capable of receiving visual information. For example, the viewer can be an operator of cellular telephone 2, a person “looking over the shoulder” of an operator of the phone, another person, or an imaging device such as a camera positioned nearby the phone. Also, while the switch in visual images can be made to occur as the viewer passes the 30 degree-from-normal angular threshold as in the above example, in alternate embodiments the threshold can be at different angles. Further, although the switch in images can be made to occur in a gradual (e.g., linear) manner as one moves beyond the angular threshold, such that the image transition occurs gradually as one approaches, passes and moves farther from the threshold, in other embodiments the switch can occur in a “digital” manner such that the transition occurs immediately and completely as one passes the threshold.

Also, the first and second visual images 18, 24 of FIGS. 1A and 1B are merely intended to be exemplary, and the present invention is intended to be representative of embodiments in which a variety of different images are provided via a touch panel such as the touch panel 10, where the images vary depending upon the orientation of a viewer relative to the touch panel. For example, in certain embodiments of the present invention, the second visual image 24 is entirely black or entirely reflective and the viewer only sees a discernable image if the viewing angle is directly normal to (or within the angular threshold of being normal to) the surface of the touch panel 10.

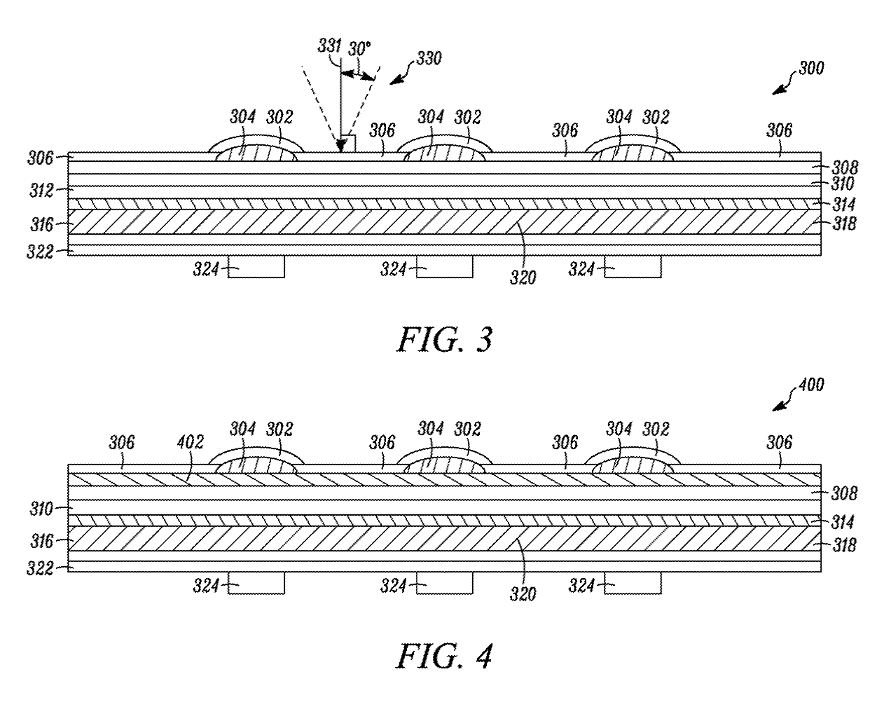

Turning to FIG. 2, there is provided a block diagram illustrating exemplary internal components 200 of the cellular telephone 2 of FIGS. 1A and 1B. Although particularly intended to be representative of the internal components of the cellular telephone 2, the block diagram is also representative of the internal components of other cellular telephones, as well as other wireless or mobile communication devices, for example, personal digital assistants or even personal computers capable of wireless communications. Also, while FIG. 2 shows the internal components 200, it should further be understood that these components are only intended to be exemplary and that the present invention is intended to encompass a wide variety of wireless communication devices that include other components in addition to those shown, and/or fail to include one or more of the components shown.

In the present embodiment, the internal components 200 include one (or possibly more than one) wireless transceiver 202, a processor 204, a memory portion 206, one or more output devices 208, and one or more input devices 210. The processor 204 can be any of a variety of different processing devices including, for example, a microprocessor. The transceiver 202 can be understood to include various transceiver circuitry as well as an antenna, and typically employs wireless technology for communication, such as CDMA technology, BlueTooth technology, etc. The internal components 200 can further include a component interface 212 to provide a direct connection to auxiliary components or accessories for additional or enhanced functionality. The internal components 200 preferably also include a power supply 214, such as a battery, for providing power to the other internal components while enabling the overall cellular telephone to be portable.

The internal components 200 can operate in conjunction with one another to perform a number of functions. For example, upon reception of wireless signals, the internal components 200 detect communication signals and the transceiver 202 demodulates the communication signals to recover incoming information, such as voice data and/or other data, transmitted by the wireless signals. After receiving the incoming information from the transceiver 202, the processor 204 formats the incoming information for the one or more output devices 208. Similarly, for transmission of wireless signals, the processor 204 formats outgoing information, which can (but need not) be activated by the input devices 210, and conveys the outgoing information to the transceiver 202 for modulation to communication signals. The transceiver 202 conveys the modulated signals to any of a variety of devices including, for example, devices that are relatively far away such as a cell tower or to devices that can be closer, such as a BlueTooth headset.

The output and input devices 208, 210 of the internal components 200 can include a variety of types of visual, audio and/or mechanical output and input devices. In the present embodiment, the output device(s) 208 at least include the display 12 of FIGS. 1A-1B, which as mentioned above can be a LCD, and which is a visual output device 216 as shown in FIG. 2. The output devices 208 also can include other visual output devices 216 such as a light emitting diode indicator, as well as one or more audio output devices 218 such as a speaker, alarm and/or buzzer, and/or one or more mechanical output devices 220 such as a vibrating mechanism.

Further, in the present embodiment, the input devices 210 include the touch panel 10 of FIGS. 1A-1B, which is a mechanical input device 226. Additionally, the input devices 210 can include one or more visual input devices 222 such as an optical sensor (for example, a camera), one or more audio input devices 224 such as a microphone, and other mechanical input devices 226 such as a flip sensor, a keyboard or keypad with one or more individual selection buttons (differing from the touch panel 10), a mouse, a capacitive sensor, a motion sensor, and a switch. In at least some embodiments (not that of FIGS. 1A-1B), the touch panel 10 and display 12 (or portions thereof) are integrated into a single input/output device, e.g., a touchscreen. Actions that actuate one or more of the input devices 210 can include, but are not limited to, pressing a button on the device (e.g., pressing a button or region of the touch panel 10), opening (or closing) of the cellular telephone, unlocking the device, moving the device to actuate a motion, moving the device to actuate a location positioning system, and operating the device.

Additionally as shown in FIG. 2, the internal components 200 can also include a location circuit 228. Examples of the location circuit 228 include, but are not limited to, a Global Positioning System (GPS) receiver, a triangulation receiver, an accelerometer, a gyroscope, or any other information-collecting device that can identify a current location of the cellular telephone (or one or more of its internal components 200).

The memory portion 206 of the internal components 200 can include any number of a variety of different types of memory devices such as random access memory (RAM) devices, and can be used to store and retrieve information. Typically, although not necessarily, operation of the memory portion 206 in storing and retrieving information is governed by commands from the processor 204. The information that is stored by the memory portion 206 can include, but need not be limited to, operating systems (or other systems software), applications, and data. Each operating system in particular includes executable code that controls basic functions of the cellular telephone 2, such as interaction among the various internal components 200, communication with external devices via the transceiver 202 and/or the component interface 212, and storage and retrieval of applications and data to and from the memory portion 216.

As for the applications, each application includes executable code that operates in conjunction with the operating system to provide more specific functionality for the cellular telephone 2, such as file system service and handling of protected and unprotected data stored in the memory portion 216. Exemplary applications can include, for example, a discovery application for discovering media on behalf of a user and his/her phone and a download user agent responsible for downloading the media object described by the download descriptor. As for the data, data is non-executable code or information that can be referenced and/or manipulated by an operating system or application for performing functions of the cellular telephone 2.

Turning to FIGS. 3-5, three exemplary embodiments of component layers of the touch panel 10 of the cellular telephone 2 of FIGS. 1A-1B are shown in more detail. The use of touch panels having component layers such as those shown in FIGS. 3-5 makes it possible for the touch panels to display varying images to viewers depending upon the respective positions of the viewers relative to the touch panels as discussed above with reference to FIGS. 1A-1B.

Referring to FIG. 3 in particular, component layers of a first version of the touch panel 10, shown as a touch panel 300, are shown in cross-section to illustrate the various layers. The cross-section can be assumed to be that taken along a line 3-3 through the touch panel 10 shown in FIG. 1A. As shown, an exterior surface (e.g., that an operator would touch with his or her finger) of the touch panel 300 is formed by two clearcoat layers 302 and 306 that are approximately 0.05 mm and 0.01 mm in thickness, respectively. The layer 302 covers over one or more (in this example, three) chrome sticker formations 304 having approximately a thickness each of 0.15 mm.

The chrome sticker formations 304 and the layer 302 atop those formations extend outwards so as to form bumps on the touch panel 300, which in turn can give the appearance of constituting buttons and serve as tactile bumps. In alternate embodiments, the chrome sticker formations 304 need not be present. Underneath the clearcoat layer 302 and surrounding the chrome sticker formations 304 is the additional clearcoat layer 306 that essentially forms the exterior surface of the touch panel 300 except in the regions where the chrome sticker formations 304 and first clearcoat layer 302 are present. Thus, the entire exterior surface of the touch panel 300 is covered by one or the other of the clearcoat layers 302, 306.

Below (or behind) the clearcoat layer 306 as well as below the chrome sticker formations 304 where those are present is an additional layer that is a privacy film polycarbonate (PC) layer 308 that in the present embodiment is approximately 0.175 mm thick (the PC layer being one exemplary type of clear resin plastic, although other similar layer(s) could be employed in alternate embodiments). Subsequently below the privacy film PC layer 308 is a privacy film louver layer 310 having a thickness of 0.15 mm and, below that, another privacy film PC layer 312 having a thickness of 0.175 mm. The three privacy film layers 308-312 form an overall privacy film that is a special material creating a special visual effect, namely, the prevention or limiting of off-axis viewing of layers below those layers. One such privacy film is the Vikuiti™ material offered by the 3M Corporation of Minneapolis, Minn.

More particularly, the privacy film louver layer 310 acts effectively as a Venetian blind so as to create a range of acceptable viewing angles 330 relative to a plane 331 normal to the touch panel 300 and extending into and out of the page as viewed by way of FIG. 3 (e.g., reference numeral 331 is directed to a cross-section of the plane). When the touch panel 300 is viewed at angles within (inside) the range of acceptable viewing angles 330 it is possible to view the regions below the privacy film layers 308-312, but when the touch panel 300 is viewed at angles beyond (outside) the range of acceptable viewing angles, viewing of the regions below the privacy film layers 308-312 is limited or impossible. It should be understood that the range 330 shown in FIG. 3 is not intended to define a region within which a viewer must be positioned in order to view through the privacy film layer, but rather represents a range of view path angles that allow a viewer to view through the privacy film layer.

In the present example, the range of acceptable viewing angles 330 created by the louver layer 310 is a wedge-shaped range encompassing angles less than or equal to 30° relative to the plane 331 normal to the surface of the touch panel 300 and, thus, if a viewer was to look at the touch panel 300 along a path that was at more than a 30° angle relative to the plane 331 or other planes normal to the touch panel and parallel to the plane 331, the layers below the louver layer and the privacy film layers 308-312 would not be visible. However, in other embodiments the range 330 can encompass larger or smaller angular ranges. It should be noted further that, as a viewer very closely approaches the touch panel 300, the viewing angle of the viewer relative to one portion of the touch panel can significantly differ from the viewing angle(s) of the viewer relative to other portion(s) of the touch panel. In such circumstances, it is possible that the viewer's view of the layers below the louver layer and the privacy film layers 308-312 will be partially but not entirely obstructed, e.g., certain portions will be visible and others will not be visible.

Because in the present embodiment the range of acceptable viewing angles 330 is a wedge-shaped range of angles measured relative to the plane 331 (e.g., a range of angles θ measured relative to the plane 331 with the vertex being at the touch panel 300), it should further be understood that a viewer's ability to view the layers of the touch panel 300 below the louver layer and the privacy film layers 308-312 will not vary as the angle of view of the viewer varies within a different range of angles formed transversely to that shown in FIG. 3 (e.g., a range of angles φ measured relative to the plane of the page of FIG. 3 with the vertex still being at the touch panel). For example, a viewer's ability to view the layers of the touch panel 300 below the louver layer and the privacy film layers will not be compromised as the viewer shifts from a view looking directly downward onto the touch panel 300 (e.g., along the line representing the cross-sectional view of the plane 331) toward a view following an oblique path toward the touch panel that obliquely cuts through the page of FIG. 3.

Further, while the range of acceptable viewing angles 330 in the present embodiment is a range of angles measured relative to the plane 331, in alternate embodiments, there can be other range(s) of acceptable viewing angle. For example, in one alternate embodiment, the range of acceptable viewing angles could be a cone-shaped range of angles measured relative to a central axis (e.g., which could be the line representing the cross-sectional view of the plane 331 shown in FIG. 3). Also, while the above-discussed ranges of acceptable viewing angles are all ranges of angles measured relative to a plane or other axis extending normally (e.g., perpendicularly) relative to the surface of the touch panel 300 (or at least some portion of the touch panel), in alternate embodiments, the ranges of acceptable viewing angles can be determined relative to planes, axes or other reference structures or directions that need not be normal to the surface of the touch panel. In still other alternate embodiments, the range of acceptable viewing angles can take other forms as well.

In any event, when the touch panel 10 is viewed outside of the range of acceptable viewing angles, the image provided can take a variety of forms depending upon the characteristics of the privacy film. For example, if the Vikuiti™ material mentioned above is used, the touch panel 10 will appear black when viewed from outside the range 330. However, in alternate embodiments, other colors, patterns or images can be visible when outside the range of acceptable viewing angles. Further, the image viewed from the touch panel 10 can change in a variety of ways as the viewer's angle of view relative to the touch panel varies from inside the range 330 to outside the range or in the opposite direction. As mentioned above, for example, the change in visible image in some embodiments can be gradual (e.g., linear), and in other embodiments can be more abrupt or instantaneous.

In the present embodiments, below the privacy film PC layer 312 is an additional layer that in the present embodiment is a UV (ultraviolet) pattern layer 314 having a thickness of approximately 0.01 mm. This layer, which is a layer of clear resin, can provide a surface topology that creates a specific desired visual effect such as, for example, a spin look, a brushed look, a carbon fiber look, or variety of other types of patterns. Next, below the UV pattern layer 314 is an electron beam vacuum metallization (EBVM) layer 316. In certain embodiments, the EBVM layer 316 can provide a spin finish appearance similar to that often found on compact discs. However, the EBVM layer 316 can also provide other appearances, or even be replaced with another type of optical coating deposition method to achieve a particular look.

Next, below the EBVM layer 316 is a printing layer 318, and below that is an adhesive layer 320 by which the printing layer is attached to a PET (polyester layer) plunger sheet 322, below which are one or more (in this case, three) plungers 324. The printing layer 318 can include a variety of markings such as lines or letters or characters or other features. For example, the printing layer 318 can include ink markings that define the boundaries of the keys/buttons and dashed lines shown as the visual image 18 of FIG. 1A. The ink markings of the printing layer 318 in particular can serve to block or absorb light incident upon the layer such that the touch panel 10 only reflects light, and thus is only visible to a viewer, from regions of the printing layer other than those that are marked with the ink markings.

The PET plunger sheet 322 and in particular the plungers 324 serve to communicate pressure impulses applied to the touch panel 10 to one or more electrical interfaces that can be positioned beneath the PET plunger sheet and plungers (the electrical interfaces not being shown.) In particular, in the present embodiment, each of the respective plungers 324 is aligned with a respective one of the chrome sticker formations 304, allowing in particular for pressure impulses applied to the clearcoat layer 302 and chrome sticker formations 304 and transmitted through the layers 308-320 of the touch panel 300 to be further transmitted to specific electrical interface mechanisms beneath the respective plungers. Nevertheless, the specific plungers 324 and chrome sticker formations 304 need not be provided in every embodiment, and in some embodiments no such formations (or associated clearcoat layers) and plungers are necessary.

In the present embodiment, the printing layer 318 has a thickness of 0.005 mm, each of the adhesive layer 320 and the PET plunger sheet 322 has a respective thickness of 0.025 mm, and each of the plungers 324 has a respective thickness of 0.2 mm. As a result, the total thickness of the touch panel 300, not counting the thicknesses of the clearcoat 302 and the chrome sticker formations 304, is 0.776 mm in the present embodiment. Thus, the touch panel 300 is quite thin, being less than a millimeter thick, and lightweight, and therefore is suitable for use in the cellular telephone 2.

The particular configuration of the layers of the touch panel 300 of FIG. 3 allows for limited variation in the visual images presented to viewers viewing the touch panel from different angles. In particular, when the viewer is viewing the touch panel within the range of acceptable viewing angles 330, a first image appears to be provided by the touch panel 300, and that image is the image provided by a combination of the UV pattern layer 314, the EBVM layer 316 and the printing layer 318. When the angle at which the viewer is viewing the touch panel 300 is outside of the range of acceptable viewing angles 330, the privacy film layers 308-312, and particularly the privacy film louver layer 310, block out the UV pattern layer 314, the EBVM layer 316 and the printing layer 318.

Although the touch panel of FIG. 3 is one embodiment in accordance with the present invention, various other embodiments of touch panels are also possible that can offer somewhat different visual characteristics than those provided by the touch panel 300. For example, referring to FIG. 4, another embodiment of the touch panel 10 is shown to be a touch panel 400. As shown, the touch panel 400 includes many of the same layers as the touch panel 300, including the clearcoat layers 302 and 306, the chrome sticker formations 304, the privacy film PC layer 308, the privacy film louver layer 310, the UV pattern layer 314, the EBVM layer 316, the printing layer 318, the adhesive layer 320, the PET plunger sheet 322 and the plungers 324, all of which in the present embodiment have the same thicknesses as those described above with reference to FIG. 3. However, in contrast to the touch panel 300, the second privacy film PC layer 312 is missing such that the privacy film louver layer 310 is directly in contact with the UV pattern layer 314, and an additional EBVM layer 402 is positioned between the clearcoat layer 306 and the privacy film PC layer 308, where that EBVM layer has a thickness of 0.001 mm in the present embodiment (such that the total thickness of the touch panel 400 not counting the layers 302 and 304 is 0.602 mm).

In the embodiment of FIG. 4, due to the incorporation of the additional EBVM layer 402, it is possible for the touch panel 400 to present not only a particular visual image when a viewer is viewing the touch panel within the range of acceptable viewing angles (as shown in FIG. 3) but also when the viewer is outside that range. More particularly, while the viewer will perceive an image based upon the printing layer, the EBVM layer 316, the UV pattern layer 314 and the additional EBVM layer 402 when the viewer is viewing the touch panel 400 within the range of acceptable viewing angles, the viewer will also perceive a different image that is not necessarily merely black (or some other color determined by the privacy film layers 308, 310) when the viewer is outside the range of acceptable viewing angles, but rather will see an image in that circumstance that is at least partially created due to the additional EBVM layer 402, for example, the image 24 shown in FIG. 1B.

Referring additionally to FIG. 5, yet a third version of the touch panel 10 is shown to be a touch panel 500. As shown, the touch panel 500 includes exactly the same layers 302-310, 314-320 and 402 as are included in the touch panel 400 of FIG. 4, in the same order as shown in FIG. 4. However, in place of the PET plunger sheet 322 and the plungers 324 of FIG. 4, the touch panel 500 instead includes a PDLC (polymer-dispersed liquid crystal) layer 502. The PDLC layer is capable of providing different images depending upon whether power (e.g., current) is applied to the layer. For example, in certain embodiments, the layer could become opaque when current was applied but be non-opaque when current was not applied. Due to the positioning of the privacy film layers (particularly the privacy film louver layer 310) above the PDLC layer 502, the effect of the PDLC layer is only discernible to a viewer when the viewer is viewing the touch panel 500 within the range of acceptable viewing angles relative to the surface of the touch panel (again as shown in FIG. 3). Thus, use of the PDLC layer 502 makes it possible for additional variation of images to occur when a viewer is looking straight at (or almost straight at) the touch panel 500 that otherwise are not apparent when the viewer is looking more obliquely toward the touch panel. In alternate embodiments, other types of electrically-switchable transmissive light structures serving as “shutters” can be employed instead of or in addition to PDLC layers, for example, twisted nematic (TN) LCDs serving as light shutters.

The embodiments of touch panels described above are only several exemplary embodiments of touch panel configurations that are possible in accordance with the present invention. Indeed, many other configurations having a variety of other arrangements of component layers and/or visual characteristics are also intended to be encompassed by the present invention. As already noted above, the particular characteristics of the privacy film, and manner of image variation that occurs as one proceeds into or out of the range of acceptable viewing angles, can vary depending upon the embodiment. While in the present embodiment, image variation occurs in a gradual manner as one proceeds into or out of the range of acceptable viewing angles, various techniques can be utilized to cause the image variation to occur in a more rapid, “digital” manner. For example, as the opacity of the louvers of the louver layer is increased, or as the spacing between adjacent louvers of the louver layer is reduced, the rapidity of the image transitioning increases.

Also, one or more of the layers that are included in the various embodiments of FIGS. 3-5 can be absent in certain embodiments. For example, as already described above, the EBVM layer 402 can be present in some embodiments and not present in other embodiments. Also, the UV pattern layer 314, the EBVM layer 316 or the printing layer 318 could be present or absent depending upon the embodiment, as can the PDLC sheet layer 502 and plunger sheet/plungers 322, 324. Further, in at least some embodiments, one or more of the layers can take the form of a lens or combination of lenses. Additionally, in at least some embodiments, a combination of passive and active visual layers can be provided below the privacy film layers to allow for variation of the views or information communicated when a viewer is able to see through the privacy film layers. Likewise, various combinations of passive and active visual layers can be provided above the privacy film layers.

It should further be evident from a comparison of FIGS. 3 and 4 with FIG. 5 that, in at least some embodiments, the touch panel 10 need not be an input device; rather, the touch panel can simply be a device that provides an image that varies depending upon the viewer's position in relation to that image. Indeed, in at least some embodiments, the touch panel can instead be merely a display or other output device or alternatively can be a touch-screen type device that allows both for the input of information as well as the output of information. Although FIGS. 3-5 only show the single adhesive layer 320, depending upon the embodiment, a variety of other connective layers or other layers used for structural or attachment purposes can also be employed. Further, the present invention is intended to encompass embodiments having layers that allow for further visual images, such as holographic images.

Further, while in the present embodiment the privacy film layers define a single range of acceptable viewing angles, in some other embodiments, there can be multiple privacy film layers that define more than one range of acceptable viewing angles. For example, in one alternate embodiment, a first (higher) privacy film layer would define a range of acceptable viewing angles that was relatively wide (e.g., plus or minus 60°) such that a viewer could continue to view everything beneath that privacy film layer if the viewers path of view was within that wide range of viewing angles, and additionally a second privacy film layer beneath that first privacy film layer that had a narrower range of view (e.g., plus or minus 30°) such that the viewer could only see what was beneath that second privacy film layer if the viewer's path of view was within that narrow range. Given such a design, three (or even possibly more) different images would become perceptible to a viewer as the viewer moved among the different ranges of acceptable viewing angles.

The present invention allowing for variations in images depending upon viewer angle can be implemented in a variety of types of cellular telephones (for example, flip phones, candy bar style phones, slider type phones, etc.) as well as other wireless communication devices (e.g., handheld devices such as personal digital assistants) and other devices. Further, the present invention is intended to encompass not only touch panels but also can be implemented in relation to a variety of other structures capable of being implemented on cellular telephones as well as other wireless communication devices and other devices. For example, the present invention is also intended to encompass touch screens and other display devices on cellular telephones such as Caller Line Identification (CLI) displays or other external surface displays on such phones. The structures need not always be planar structures but rather could be, for example, structures having a curved (e.g., cylindrical) outer surface.

Indeed, the present invention is intended to encompass a wide variety of structures and devices having privacy film layer(s) or similar layer(s) that limit viewing of layers or structures beneath or behind the privacy film/similar layer(s) from above or in front of the privacy film/similar layer(s) to views that approach the privacy film/similar layer(s) from within certain angular range(s). In short, in accordance with these and other embodiments of the present invention, the present invention is capable of affording touch panels and other structures such as touch screens and displays that provide a distinctive, varying visual performance relative to conventional structures that can in at least some circumstances be considered “morphing” behavior. At the same time, many of these embodiments also afford touch panels and other structures that can be sufficiently thin, lightweight and/or cost-effective to allow for their implementation into cellular telephone, other portable wireless communication devices, and other devices.

It is specifically intended that the present invention not be limited to the embodiments and illustrations contained herein, but include modified forms of those embodiments including portions of the embodiments and combinations of elements of different embodiments as come within the scope of the following claims.

We claim:

1. In a cellular telephone, a structure configured to provide multiple visual images, the structure comprising:
a first layer; and
a second layer positioned behind the first layer, the first and second layers being supported upon the cellular telephone,
wherein the first layer is configured to restrict a viewing of the second layer from a first location in front of the first layer when a view path between the first location and the structure forms an angle relative to an axis extending from the structure that exceeds an angular threshold,
whereby first and second images that differ from one another are respectively provided by the structure and visible at the first location depending upon whether the view path exceeds or does not exceed the angular threshold, respectively.

2. The structure of claim 1, wherein the structure is one of a touch panel, a touch screen and a Caller Line Identification display, and wherein the cellular telephone is one of a flip phone, a candy bar style phone, and a slider type phone.

3. The structure of claim 1, wherein the first layer is a privacy film layer that includes a louver layer and at least one polycarbonate (PC) layer adjacent to the louver layer.

4. The structure of claim 1, wherein the second layer includes an ultraviolet pattern layer.

5. The structure of claim 1, wherein the second layer includes an electron beam vacuum metallization (EBVM) layer.

6. The structure of claim 5, wherein the second layer additionally includes an ultraviolet pattern layer positioned in between the EBVM layer and the first layer, and wherein the axis is within a plane that extends normally away from a surface of the structure.

7. The structure of claim 1, further comprising a third layer positioned behind the second layer.

8. The structure of claim 7, wherein the third layer includes a printing layer.

9. The structure of claim 7, wherein the third layer includes an additional layer that is one of a plunger layer and a polymer-dispersed liquid crystal (PDLC) layer.

10. The structure of claim 9, wherein the third layer includes the PDLC layer, and wherein the first image takes a first form when a first signal is provided to the PDLC layer turning the PDLC layer on, and wherein the first image takes a second form when the first signal is not provided to the PDLC layer.

11. The structure of claim 9, wherein the third layer includes a printing layer, and an adhesive layer connecting the printing layer within the additional layer.

12. The structure of claim 7, further comprising a fourth layer positioned in front of the first layer, and wherein the fourth layer includes a first EBVM layer.

13. The structure of claim 12, wherein the fourth layer includes at least one of a chrome sticker formation and a clearcoat layer.

14. The structure of claim 12, wherein the fourth layer includes the chrome sticker formation, which at least in part forms a tactile-bump, and wherein the third layer includes a plunger layer and a plunger aligned with the tactile-bump, so that a pressure impulse applied to the tactile-bump results in a corresponding pressure impulse that can be transmitted to an electrical device positioned behind the plunger.

15. The structure of claim 1, further comprising an additional layer positioned in front of the first layer, wherein the additional layer is configured to restrict a viewing of the second layer from the first location in front of the first and additional layers when the angle formed between the view path and the axis exceeds an additional angular threshold,
whereby a third image differing from the first and second images is provided by the structure and visible at the first location when the view path exceeds the additional angular threshold.

16. The structure of claim 1, wherein a transition between the first and second images as the view path moves between exceeding and not exceeding the angular threshold occurs in a gradual, substantially linear manner.

17. A touch panel for a wireless communication device, the touch panel comprising:
a first layer that forms an exterior surface of the touch panel;
a second layer that includes a privacy film layer; and
a third layer behind the second layer that provides a first image,
wherein the first image is substantially only visible from a location beyond the exterior surface of the touch panel if a path extending between the location and the exterior surface is within a first angular range of an axis extending from the exterior surface.

18. The touch panel of claim 18, wherein the third layer includes a means for transmitting a pressure impulse applied to the first layer to an electrical device positioned behind the transmission layer.

19. A method of providing a morphing appearance of a surface of a wireless communication device, the method comprising:
providing a cellular telephone having a structure including a privacy film layer and an image-creating layer behind the privacy film layer;
providing first output light that communicates at least a portion of a first image determined by the image-creating layer when the output light is transmitted by way of a first path that is within a first angular range of a direction relative to the surface of the structure; and
providing second output light that communicates at least a portion of a second image differing from the first image when the output light is transmitted by way of a second path that is outside of the first angular range.

20. The method of claim 20, wherein the structure is formed by assembling the privacy-film layer in relation to the image-creating layer, additionally coupling the image-creating layer to an additional layer capable of transmitting pressure impulses to a pressure-responsive device, and further coupling the privacy-film layer to at least one of an additional image-creating layer, a protective film layer, and a sticker formation layer.
